(19) United States
(12) Patent Application Publication
(10) Pub. No.: US 2012/0299838 A1
(43) Pub. Date: Nov. 29, 2012

(54) User Touch Screen Interface Device

(75) Inventors: Eric J. Flachbart, Newport Center, VT (US); Cayle Erik Waring, Kirby, VT (US); Todd Leadbeater, Saint Johnsbury, VT (US); Duane Edward Allen, Sheffield, VT (US); Rolf Eric Zuk, Monroe, NH (US); Farzeen Hussain, Lyndonville, VT (US)

(73) Assignee: Numia Medical Technology, LLC, Lyndonville, VT (US)

(21) Appl. No.: 13/115,365

(22) Filed: May 25, 2011

(51) Int. Cl. G06F 3/041

(52) U.S. Cl. 345/173

(57) ABSTRACT

The present invention provides an apparatus, a method, and a system with which a user can easily and precisely select unlimited displaying data and enter text information on a touch screen with a small dimension. The user touch screen interface device comprises a first member, a selection member, an actuation member, and a detent mechanism. Means to response to selection and actuation of stored application data are also disclosed.

### BACKGROUND OF RELATED ART

This invention is related to a user touch screen interface device with which a user can easily and precisely select unlimited display data on a touch screen and readily enter text information.

Portable electronic devices such as cellular phones, personal digital assistants (PDAs), video camcorders, digital cameras, and small mobile computing devices are becoming increasingly popular. All of these devices have a user interface to store information and perform tasks under the direction of the users of the devices. A touch screen, an intuitive computer input device that works by simply touching the display screen with a finger or a stylus, rather than by typing on a keyboard or pointing with a mouse, is usually utilized as a user interface for these portable electronic devices for the reduction in the size of them.

As the size of these devices decreases, the size of their touch screen reduces correspondingly, but the number of functions displayed on their touch screen is rising, the density of information on these display screens therefore is increasing. Hence, the relative wide dimension of fingers and difficulty in making a precise movement in small increments limits fingers in making accurate selection on these screens.

U.S. Pat. No. 6,278,443 relates an on-screen mouse in tackling the above problems caused by the high density of information and the limitation of human fingers. A user moves a cursor or pointer to select information displayed on a screen by rolling his finger on a screen in an orthogonal direction, a means to detect the rolling, and a means responsive to this detection. However, disadvantages associated with the method provided in this patent are cumbersome and time consuming. Additionally, it is difficult to move a cursor precisely on a touch screen with a small dimension and crowded data.

U.S. Pat. No. 7,215,321 details a tactile input device to transmit user information to a user interface interpretation module. The number of functionalities provided by this input device proportionates to the physical space of the input device; a larger number of functionalities would require a bigger input device.

U.S. Pat. No. 6,727,830 provides a method and system for extending the functionalities of an application button on a resource constrained computing device by pressing an application button for various lengths of time. The problem with this patent is that a user of the device has to count length of time of press matching an intended functionality and the device offers very limited functionalities.

The present invention provides solutions to the above problems caused by crowded screens and physical limitations of interface devices, and provides a versatile tactile user touch screen interface device with the benefit that a user can readily actuate application data and enter text information in a small touch screen.

### SUMMARY

In a computer-controlled system, with a touch screen, having a user touch screen interface device and stored application data, the user touch screen interface device comprises a first member, affixed on the touch screen, having an inside surface, a selection member having an outside surface, an inside surface, a top surface, and a bottom surface, and the selection member fits inside the first member and is movable against the inside surface of the first member to select data, and an actuation member positioned inside the selection member, and the actuation member having a button selector connected by a bias element to a base contacting the touch screen. When pressed, the actuation member actuates the application data selected by the selection member and provides a tactile feedback.

In one embodiment, the selection member further comprises a selection point on the bottom surface of the selection member. When moving the selection member by placing a finger tip in a finger dent, opposite the selection point, on the top surface of the selection member, the selection point contacts the touch screen in various positions and the application data thereby are selected.

In one embodiment, the user touch screen interface device further comprises software which comprise (1) a selection means enabling the detection of the position of the selection point associated with the application data to select the application data; and (2) an actuation means responsive to the press of the button selector to actuate the application data selected by the selection means.

In one embodiment, the user touch screen interface device further comprises a detent mechanism including a plurality of indentations on the inside surface of the first member and a plurality of bias elements attached to the outside surface of the selection member capable of being compressed against the inside surface of the first member or vice versa. The above summary is not intended to describe every embodiment or implementation of the present invention. These and other features, aspects, and advantages of the present invention will become better understood with reference to the following description, appended claims, and accompanying drawings.

### BRIEF DESCRIPTION

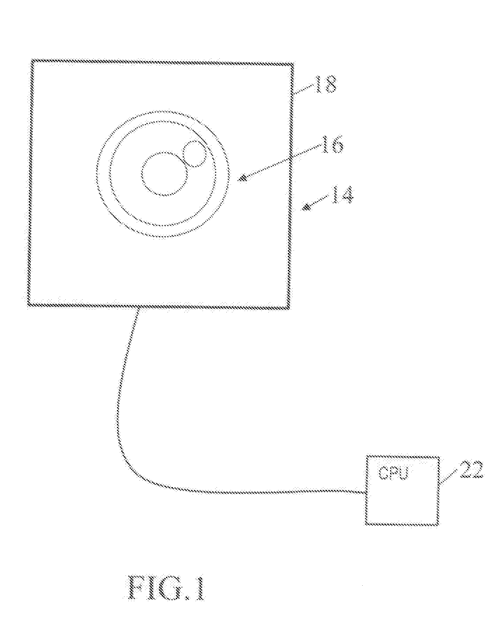

FIG. 1 illustrates a user touch screen interface device used in a computer-controlled system.

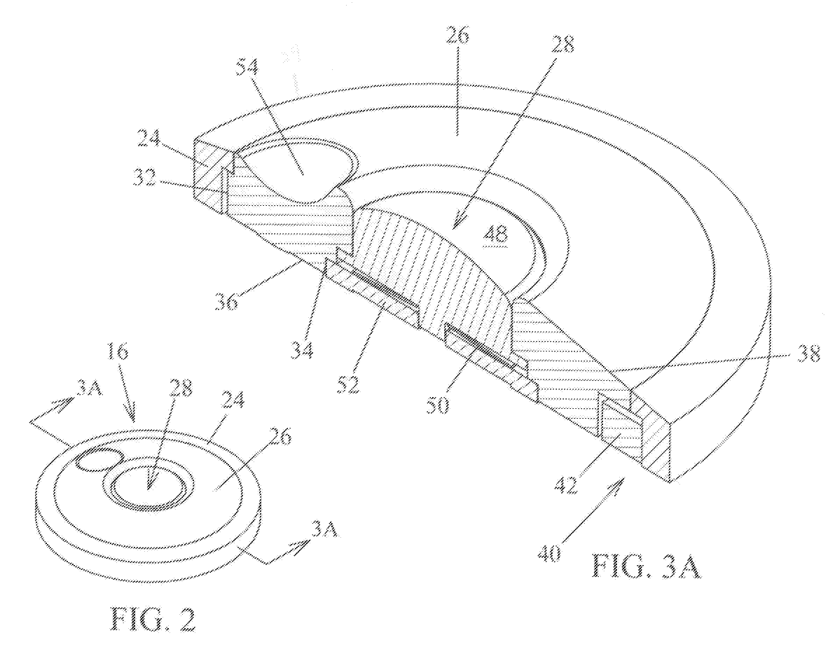

FIG. 2 is a perspective view of the user touch screen interface device.

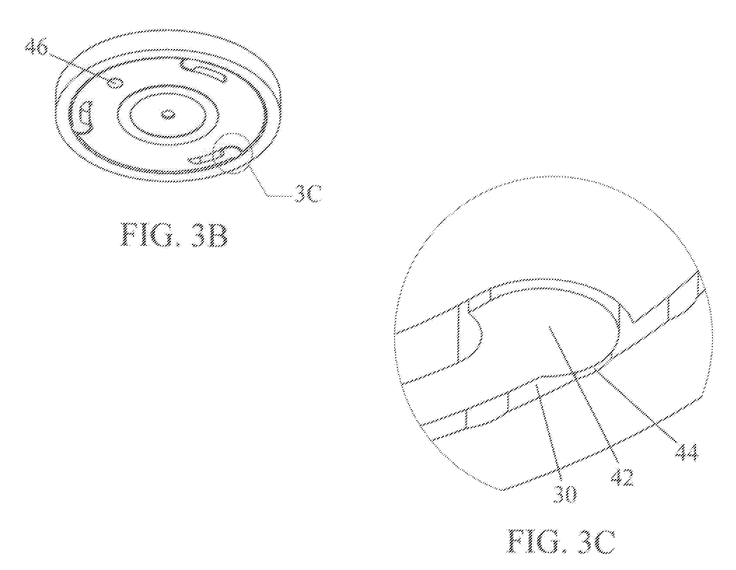

FIG. 3A is a sectional view of the user touch screen interface device.

FIG. 3B is a view showing a selection point and springs on the selection member of the user touch screen interface device.

FIG. 3C is an enlarged view demonstrating indentations on the inside surface of the first member and those springs on the outside surface of the selection member of the user touch screen interface device.

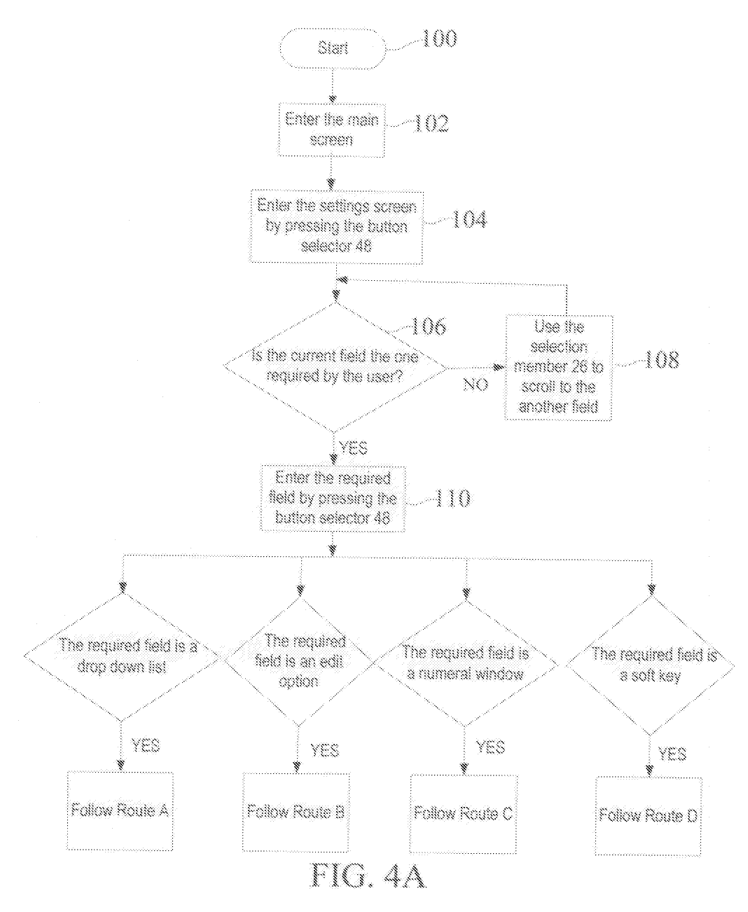

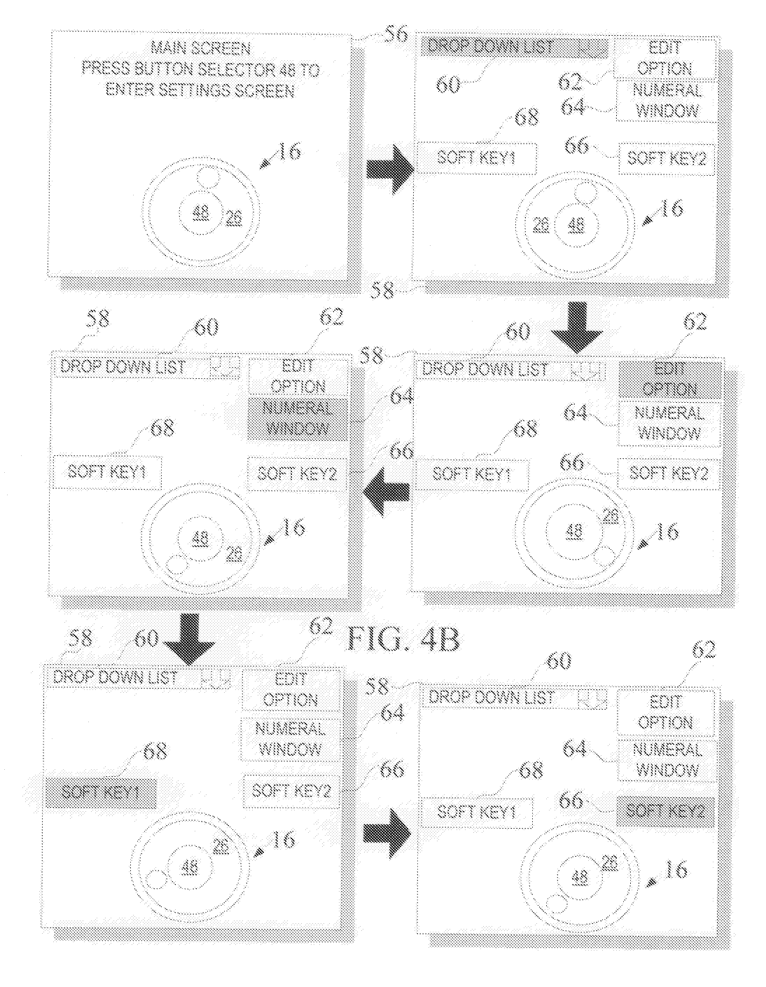

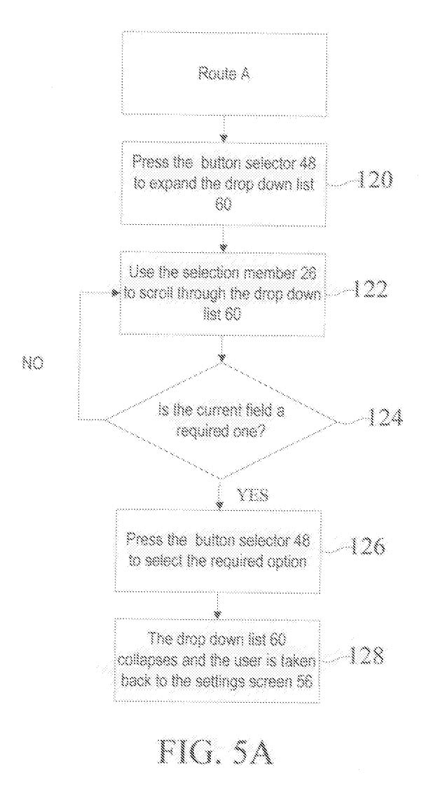

FIG. 4A is a flowchart illustrating how to enter main application fields by using the user touch screen interface device.

FIG. 4B is a block diagram illustrating how to enter those main application fields by using the user touch screen interface device.

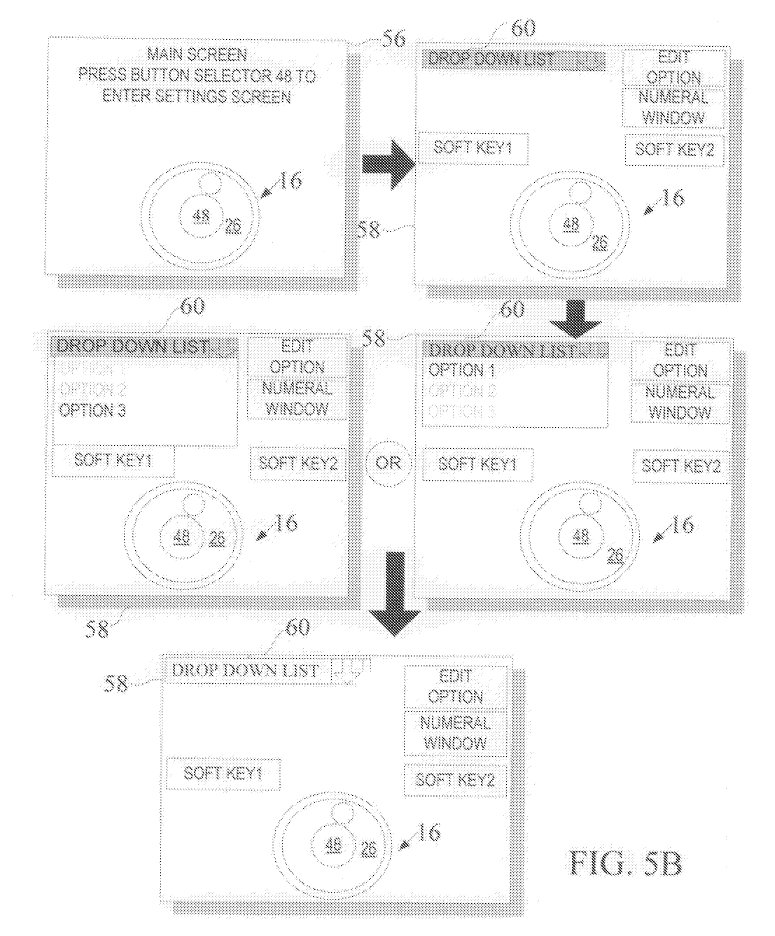

FIG. 5A is a flowchart illustrating how to select and actuate application data in a drop down list by using the user touch screen interface device.

FIG. 5B is a block diagram illustrating how to select and actuate the application data in the drop down list by using the user touch screen interface device.

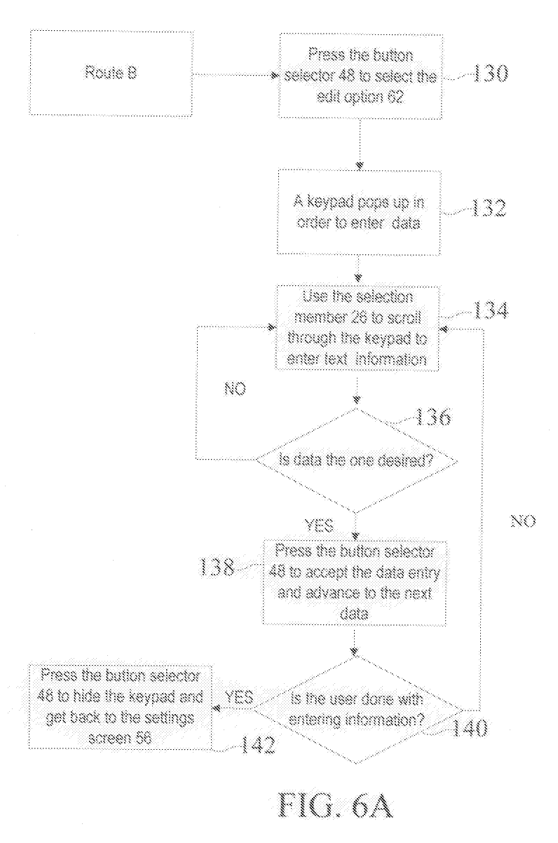

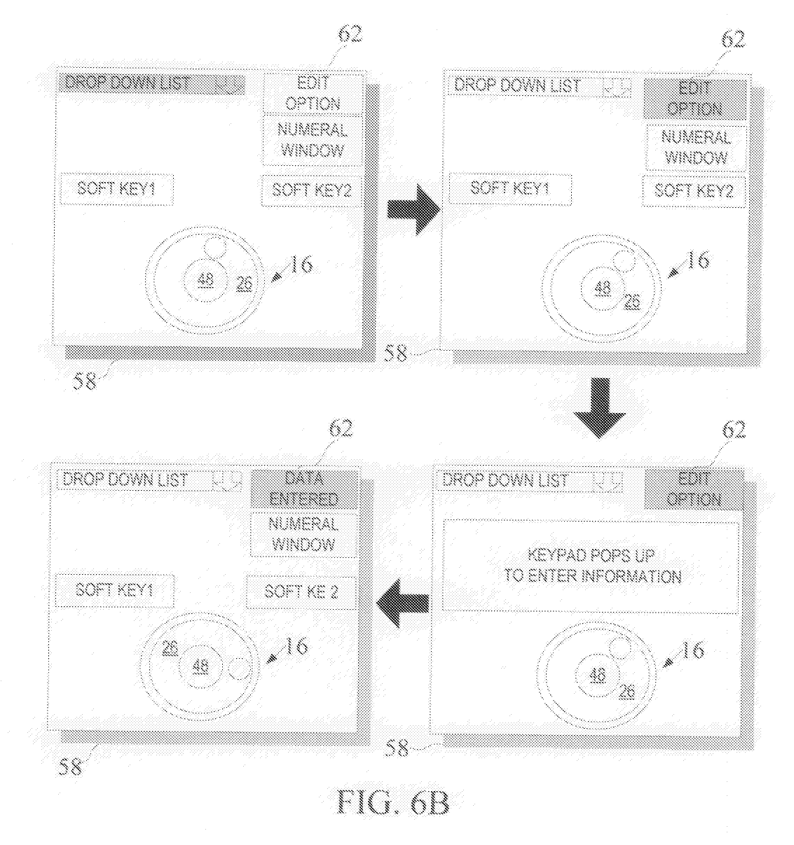

FIG. 6A is a flowchart illustrating how to enter text information in an edit option by using the user touch screen interface device.

FIG. 6B is a block diagram illustrating how to enter text information in the edit option by using the user touch screen interface device.

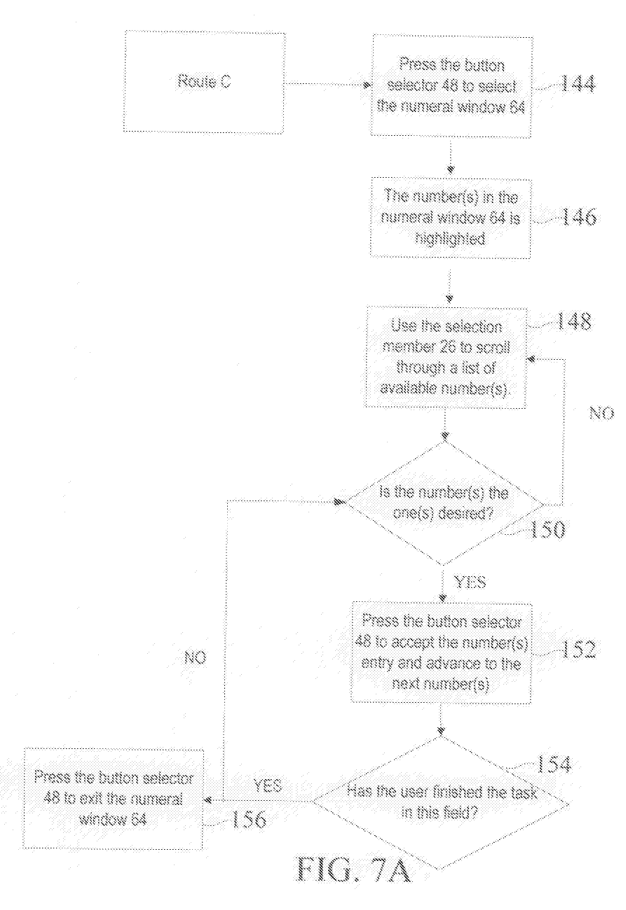

FIG. 7A is a flowchart illustrating how to enter number(s) by using the user touch screen interface device.

FIG. 7B is a block diagram illustrating how to enter the number(s) by using the user touch screen interface device.

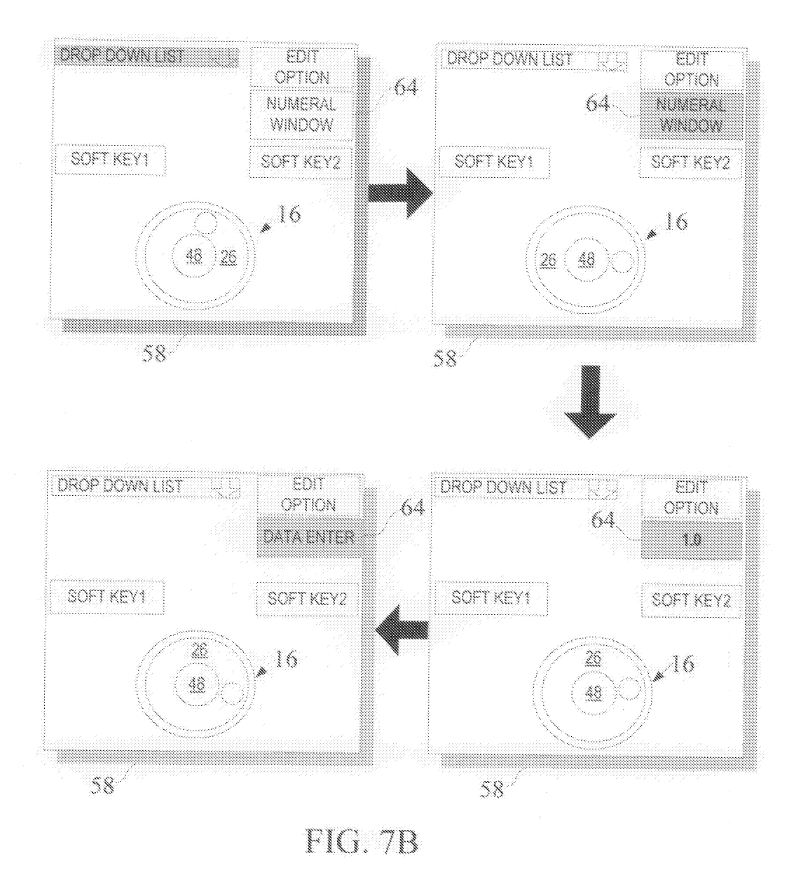

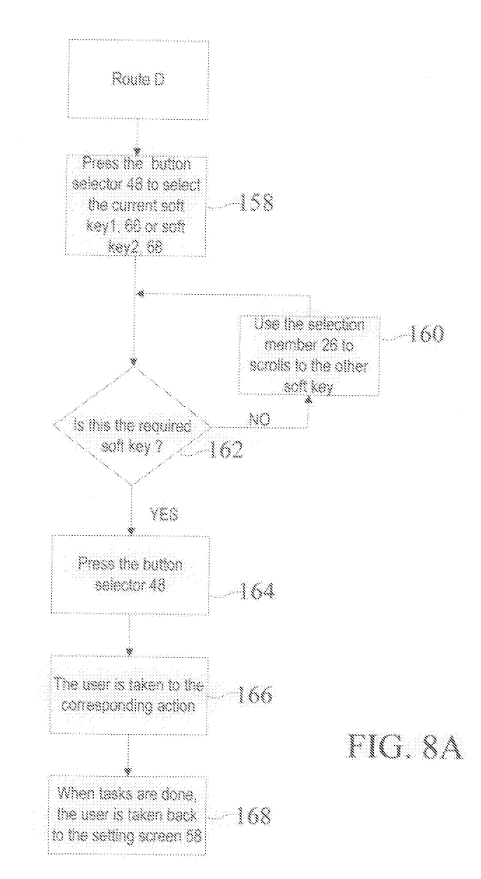

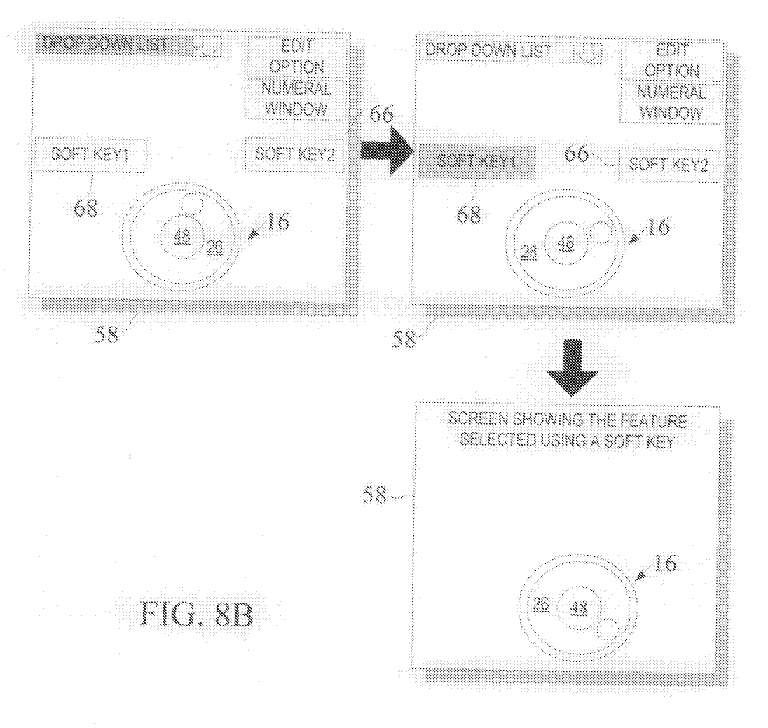

FIG. 8A is a flowchart illustrating how to operate soft key1 or 2 by using the user touch screen interface device.

FIG. 8B is a diagram illustrating how to operate the soft key1 or 2 by using the user touch screen interface device.

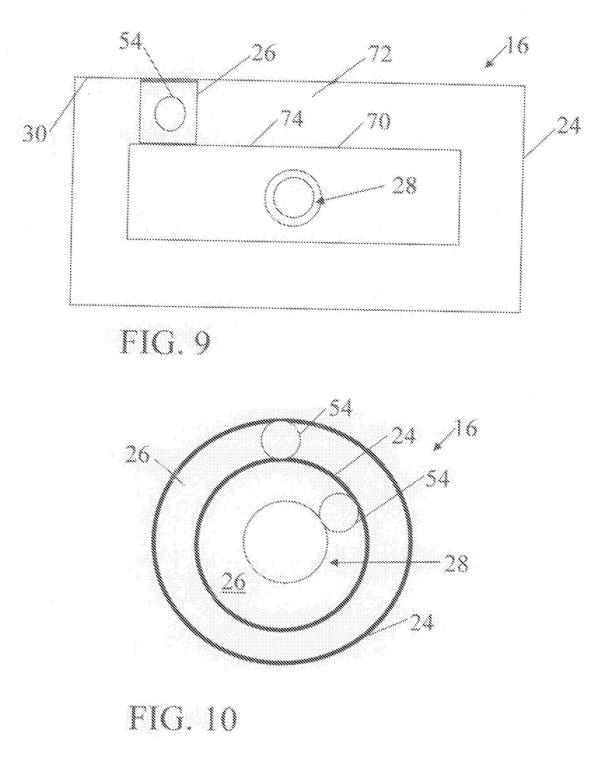

FIG. 9 shows an embodiment of a rectangular user touch screen interface device.

FIG. 10 shows an embodiment of the user touch screen interface device with two first members and two selection members.

### DETAILED DESCRIPTION

The following description is merely exemplary in nature and is in no way intended to limit the invention, its application, or use.

As shown in FIG. 1, a computer-controlled system 14 comprises a user touch screen interface device 16, a touch screen 18, and a central processing unit (CPU) 22. A software system interprets the output of the touch screen 18 when the user touch screen interface device 16 is operated. The CPU 22 converts an analog output of the touch screen 18 into a response appropriate for an active CPU function. Application data that are manipulated and edited by the user touch screen interface device 16 of the present invention are stored in the computer-controlled system 14.

In one embodiment, referring to FIG. 2, the user touch screen interface device 16 comprises a first member 24, a selection member 26, and an actuation member 28. The first member 24 is affixed on or attached on the touch screen 18 shown in FIG. 1 by a fastening means such as adhesive, e.g. cyanoacrylate, and screws.

In one embodiment, referring to FIGS. 3A, 3B, and 3C, the selection member 26 is a ring selector—the first member 24 and the selection member 26 are in the shape of a circle—rotatable in both a clockwise direction and a counterclockwise direction engaging the inside surface 30 of the first member 24. The selection member 26 has an outside surface 32, an inside surface 34, a bottom surface 36, and a top surface 38. The actuation member 28 is round.

In one embodiment, referring to FIGS. 2, 3A, 3B, and 3C, the user touch screen interface device 16 further comprises a detent mechanism 40. The detent mechanism 40 is provided by a plurality of indentations 44 on the inside surface 30 of the first member 24 coupled with a plurality of bias elements 42, such as springs or spring arms, integral or attached to the outside surface 32 of the selection member 26 or vice versa. The detent mechanism 40 provides a mechanical arrest or resistance to the move of the selection member 26 and a sensation of the move and a tactile feedback. Additionally, the plurality of the bias elements 42 and the plurality of indentations 44 have a function in helping the selection member 26 engage the first member 24 by the interaction between the indentations 44 and the bias elements 42, when the selection member 26 moves against the first member 24. Those indentations 44 are equally spaced apart from one another or spaced by any desired distance apart from one another on the inside surface 30 of the first member 24.

In one embodiment, each indentation of the plurality of indentations 44 is associated with a function implemented by the selection member 26.

In one embodiment, the user touch screen interface device 16 further comprises a selection point 46 on the bottom surface 36 of the selection member 26. Moving the selection member 26 by placing a finger tip in a finger dent 54, opposite the selection point 46, on the top surface 38 of the selection member 26, the selection point 46 contacts the touch screen 18 shown in FIG. 1 in various positions which are associated with the application data and the application data thereby are selected.

In one embodiment, the actuation member 28 comprises a button selector 48, a bias element 50 such as a spring, and a base 52 contacting the touch screen 18 shown in FIG. 1. The bias element 50 is positioned between the button selector 48 and the base 52, and the bias element 50, when pressed, gives a user a tactile feedback such as a click sensation.

In one embodiment, the user touch screen interface device 16 further comprises software which comprise (1) a selection means enabling detection of the position of the selection point 46 associated with the application data to select the application data; and (2) an actuation means responsive to press of the button selector 48 to actuate the application data selected by the selection means. The software is a code program stored in a computer readable medium or the CPU 22 in FIG. 1.

As illustrated in FIG. 4A and FIG. 4B, one of the significant features of this device is that a user is not required to push or press a small key to actuate each stored individual function. At the same time electronic device starts in step 100, step 102 sets up a main screen 56. Pressing the button selector 48 in step 104, a setting screen 58 is displayed with a focus on a default input field—a drop down list 60. A determination is made as to whether the current field is the one required, step 106. If no, in step 108, a user uses the selection member 26 to scroll to another input field such as an edit option 62, a numeral window 64, or soft key1 66, and soft key2 68. If yes, in step 110 the user initiates the required field by pressing the button selector 48. If the required field in the step 110 is the drop down list 60, follow a route A. If the required field in the step 110 is the edit option 62, follow a route B; if the numeral window 64, follow a route C; if the soft keys 66 or 68, follow a route D.

FIGS. 5A and 5B show the route A. Pressing the button selector 48 allows the expansion of the drop down list 60, step 120. Using the selection member 26 to scroll through the drop down list 60, step 122, as illustrated in FIG. 5B, allows option 1, option 2, or option 3 to be chosen. In step 124, a determination is made as to whether the focused option is the one desired. If no, return to the step 122. If yes, press the button selector 48 to actuate the selected option, step 126. After a task in the drop down list 60 is done, the drop down list 60 collapses and a user exits the drop down list 60, step 128.

FIGS. 6A and 6B show the route B. Pressing the button selector 48 in step 130 starts current edit option 62; a keypad pops up in step 132. By using the selection member 26 scrolling through the keypad in combination with pressing the button selector 48, a user can enter text information. Specifically, scrolling through the keypad in step 134, if the data is the one desired in step 136, press button selector 48 to accept the data, step 138; otherwise go back to the step 134. If the decision is yes as to whether the user is done with entering information, step 140, exit the edit option 62 by pressing the button selector 48, the keypad is hidden, and get back to the setting screen 56, step 142. If the decision is no as to whether the user is done with entering information in the step 140, return to the step 134 and repeat scrolling through the keypad.

FIGS. 7A and 7B show the route C. Press the button selector 48 in step 144 to start to enter number(s); the number(s) in the numeral window 64 is highlighted, step 146. By using the selection member 26 scrolling through the available numerals in combination with pressing the button selector 48, a user can enter numeral information. Specifically, scrolling through a list of available number(s) in step 148, if the data is the one desire in step 150, press the button selector 48 to accept the data, step 152; otherwise go back the step 148. If the decision is yes as to whether the user is done with entering numeral information, step 154, exit the numeral window 64 by pressing the button selector 48, step 156. lithe decision is no as to whether the user is done with entering information in the step 154, then go back to the step 150.

FIGS. 8A and 8B show the route D. Pressing the button selector 48 initiates the soft keys 66 or 68 in step 158. An inquiry is made as to whether the selected item is one required, step 162. If no, scroll to the other soft key feature by using the selection member 26, step 160; if yes, press the button selector 48 to start the function of the selected soft key feature, step 164, and the user is going to be taken to a corresponding action stored in the computer-controlled system 14 in step 166. When tasks of the soft keys 66 or 68 are done, the user is taken back the setting screen 58 in step 168.

In one embodiment, the inner periphery of the first member 24 is in the shape of a circle and the outer periphery of the first member 24 is in various geometric shape, for example, a triangular, rectangular, oval shape, heart shape and etc. The selection member 26 is round and rotates in both a clockwise direction and a counterclockwise direction engaging the inside surface 30 of the first number 24.

In one embodiment, the first member 24 and the election member 26 are in other geometric shapes, for example, triangular, rectangular, oval shape and etc. In the case of the shape of a rectangle, referring to FIG. 9, the user touch screen interface device 16 further comprises a guide member 70. The selection member 26 is a rectangle or square slidable, in a channel 72 formed by the guide member 70 and the first member 24, against either the inside surface 30 of the first member 24 or an outside surface 74 of the guide member 70 or both of these two surfaces. The dimension of the selection member 70 is adapted to the dimension of the channel 72 to move therein. The actuation member 28 is positioned inside the guiding member 70 and is in various shapes and the inner periphery of the guide member 70 is adapted to accommodate the shape of the actuation member 28 so that the button selector 48 is able to be pressed. In one embodiment, the detent mechanism 40 comprises the plurality of indentations 44 on the inside surface 30 of the first member 24 coupled with the plurality of bias elements 42, such as springs or spring arms, integral or attached to the outside surface 32 of the selection member 26 or vice versa. In another embodiment, the detent mechanism 40 comprises the plurality of indentations 44 on the inside surface 34 of the election member 24 couple with the plurality of bias elements 42, such as springs or spring arms, integral or attached to the outside surface 74 of the guide member 70 or vice versa.

In one embodiment, the user touch screen interface device 16 comprises more than one selection member 26 and first member 24. FIG. 10 illustrates the user touch screen interface device 16 having two selection members 26 and two first members 24. The user touch screen interface device 16 with multiple selection members 26 and first members 24 can be in other shapes such as a rectangle or a square if the guide member 60 is provided.

In one embodiment, the user touch screen interface device 16 in FIG. 2 is made of rigid materials such as plastics, metals, and glasses.

In one embodiment, the touch screen 18 in FIG. 1 is a resistive touch screen. In another embodiment, the touch screen 18 in FIG. 1 is a capacitive touch screen; the user touch screen interface device 16 is made of electrically conductive material such as a silver impregnated plastic or copper.

What is claimed is:

1. In a computer-controlled system, with a touch screen, having a user touch screen interface device and stored application data, the user touch screen interface device comprising:
a first member having an inside surface, wherein the first member is affixed on the touch screen by a fastening means,
a selection member having an outside surface, an inside surface, a top surface, and a bottom surface, wherein the selection member fits inside the first member and is movable against the inside surface of the first member to select the application data, and
an actuation member positioned inside the selection member, wherein the actuation member having a button selector connected by a bias element to a base contacting the touch screen, wherein when pressed, the button selector actuates the application data selected by the selection member and provides a tactile feedback.

2. The user touch screen interface device of claim I, wherein the selection member further comprising a selection point on the bottom surface of the selection member, wherein moving the selection member by placing a finger tip in a finger dent, opposite the selection point, on the top surface of the selection member, the selection point contacts the touch screen in various positions associated with the application data and the application data thereby are selected.

3. The user touch screen interface device of claim 2 further comprising software which comprise
(1) a selection means enabling detection of the position of the selection point to select the application data, and
(2) an actuation means responsive to the press of the button selector to actuate the application data selected by the selection means.

4. The user touch screen interface device of claim 3, wherein the software is a code program stored in a computer readable medium or CPU.

5. The user touch screen interface device of claim 3, wherein the software expands display of the application data in a drop down list and actuate the application data aforementioned.

6. The user touch screen interface device of claim 3, wherein the software is capable of entering text information on the touch screen.

7. The user touch screen interface device of claim 3, wherein the software is able to edit and actuate programmable application data of the application data.

8. The user touch screen interface device of claim 1 further comprising a detent mechanism.

9. The user touch screen interface device of claim 8, wherein the detent mechanism includes a plurality of indentations on the inside surface of the first member coupled with a plurality of bias elements attached to the outside surface of the selection member capable of being compressed against the inside surface of the first member or vice versa.

10. The user touch screen interface device of claim 8, wherein the plurality of bias elements are springs or spring arms integrated to the selection member.

11. The user touch screen interface device of claim 8, wherein each indentation of the plurality of indentations is associated with the application data.

12. The user touch screen interface device of claim 1, wherein an inner periphery of the first member and the selection member are in the shape of a circle and the selection member is round and rotates both in a clockwise direction and in a counterclockwise direction in contact with the inside surface of the first number, wherein an outer periphery of the first member is in various shapes.

13. The user touch screen interface device of claim 1, further comprises a guide member, wherein the first member and the selection member are in the shape of a rectangle and the selection member is slidable against the inside surface of the first member or an outside surface of the guide member or both of those two surfaces aforementioned in a channel formed between the selection member and the guide member, wherein the dimension of the selection member is adapted to the dimension of the channel to move therein, wherein the actuation member in various shapes is positioned in the guiding member, wherein an inner periphery of the guide member is in the shape to accommodate the shape of the actuation member.

14. The user touch screen interface device of claim 13 further comprising a detent mechanism including at least one selected from the group consisting of the plurality of indentations on the inside surface of the first member coupled with the plurality of bias elements attached to the outside surface of the selection member or vice versa, or the plurality of indentations on the inside surface of the election member couple with the plurality of bias elements attached to the outside surface of the guide member or vice versa.

15. The user touch screen interface device of claim 1, wherein the touch screen is a resistive touch screen.

16. The user touch screen interface device of claim 1, wherein the touch screen is a capacitive touch screen, wherein the user touch screen interface device is made of an electrically conductive material.

17. The user touch screen interface device of claim 16, wherein the electrically conductive material is a silver impregnated plastic or copper.

18. In a computer-controlled system, with a touch screen, having stored application data, a method to implement and edit the application data comprising
providing a first member having an inside surface and affixing the first member on the touch screen by a fastening means,
providing a selection member having an outside surface, an inside surface, a top surface, a bottom surface, and a selection point on the bottom surface, movable against the inside surface of the first member to select the application data, inside the first member,
providing an actuation member positioned inside the selection member and having a button selector connected by a bias element to a base contacting the touch screen,
wherein when pressed, the actuation member actuates the application data selected by the selection member and provides a tactile feedback,
providing a selection means enabling the detection of the application data selected by the selection member through a contact between the selection point and the touch screen, and
providing an actuation means responsive to the press of the button selector to actuate the application data selected by the selection means.

19. The method to implement and edit the application data of claim 18 further comprising providing a detent mechanism including a plurality of indentations on the inside surface of the first member and a plurality of bias elements attached to the outside surface of the selection member capable of being compressed against the inside surface of the first member or vise versa.

20. A computer-controlled system, with a touch screen, having stored application data, and a user touch screen interface device, with a detent mechanism, that has a selection member to select the application data and a tactile actuation member to actuate the selected application data, and a computer program for manipulating and editing the stored application data by the user touch screen interface device, the computer program for manipulating and editing the stored application data by the user touch screen interface device comprising
a selection means enabling the detection of the application data selected by the selection member, and
an actuation means responsive to an actuation done by the actuation member to actuate the application data selected by the selection means.

21. The computer program for manipulating and editing the stored application data by the user touch screen interface device of claim 20 expands the application data of a drop down list and actuates the application data aforementioned.

22. The computer program for manipulating and editing the stored application data by the user touch screen interface device of claim 20 is capable of entering text information on the touch screen.

23. The computer program for manipulating and editing the stored application data by the user touch screen interface device of claim 20 is able to edit and actuate programmable application data of the application data.

24. The computer program for manipulating and editing stored application data by the user touch screen interface device of claim 20, wherein the selection means and the actuation means act in series.
